(19) United States
(12) Patent Application Publication
(10) Pub. No.: US 2026/0116786 A1
(43) Pub. Date: Apr. 30, 2026

(54) DESALINATION AIR COOLING SYSTEM AND METHOD

(71) Applicant: KUWAIT UNIVERSITY, Safat (KW)

(72) Inventor: Bader Al-Anzi, Safat (KW)

(21) Appl. No.: 18/925,576

(22) Filed: Oct. 24, 2024

(51) Int. Cl. C02F 1/14; B01D 1/00; B01D 1/30; B01D 5/00; C02F 1/04; C02F 103/02; C02F 103/08; F28C 1/00

(52) U.S. Cl. CPC C02F 1/14; B01D 1/0041; B01D 1/30; B01D 5/006; C02F 1/043; C02F 2103/023; C02F 2103/08; F28C 2001/006

(57) ABSTRACT

A desalination and air cooling system includes a desalination chamber using solar energy, a ventilation structure and cooling tower. The ventilation structure is attached to the desalination chamber and includes a fan and a heat exchanger. A cooling tower provides cooling liquid for the heat exchanger and includes a base portion, middle, and outlet portions. One or more inlets introduce air onto a top surface of cooling liquid in the cooling tower. The middle and top outlet portions are configured to induce a convection current over the cooling liquid. The middle portion of the cooling tower is tapered and the top outlet portion may be a dark opaque color for attracting sunlight and creating warm air within the outlet portion and induction of cooler air entering through the inlets of the cooling tower. Benefits of the system include producing purified water and cool air through a natural cooling system.

### BACKGROUND

### Field

The disclosure of the present patent application relates to desalination systems, and particularly to a desalination system and method using a natural cooling tower.

### Description of Related Art

Desalination refers to the process of removing salts from water for conversion into fresh water suitable for potable uses. Saudi Arabia's desalination plants account for about 24% of total world capacity. The world's largest desalination plant is the Jobel Ali Desalination Plant in the United Arab Emirates. It is a dual-purpose facility that uses multi-stage flash distillation and is capable of producing 300 million cubic meters of water per year. The largest desalination plant in the United States is located in Tampa, Florida and began desalinizing 25 million gallons of water per day in December of 2007.

Worldwide, 13,080 desalination plants produce more than 12 billion gallons of water per day, according to the International Desalination Association. There are two common desalination processes used to produce potable water: Multistage Flash (MSF) and Reverses Osmosis (RO). In MSF, sea water is boiled at a lower temperature by controlling the chamber pressure to be less than atmospheric pressure and extracting distilled water in the form of vapor. This vapor is converted to condensate and collected from the rest of the chambers to form the final distilled product.

However, MSF or thermal desalination is a costly process because it requires high energy consumption. Lately, during the last decade, the use of Reverse Osmosis for desalination technology has been rising fast due to its low energy consumptions, which reduces desalination costs substantially. Generally, membranes work as filters by using semi-permeable membranes and pressure to separate salts from water. In RO processes, a hydrophilic membrane filter that is selectively permeable to water, is used to reject a portion of solutes.

Most recent studies focus on cost-effective ways of producing fresh water for human consumption, especially in hot and arid regions where water resources are limited. Currently, there are various sources of energy which could potentially be used to operate desalination plants. Such energy comes from fossil fuel, nuclear and most recently solar and wind energy. Although solar energy is a relatively recent technology and depends heavily on the weather, it is safer, cheaper and more environmentally friendly than fossil fuel and nuclear energy. This has encouraged researchers to investigate the viability of solar and wind-driven power as renewable sources of energy to minimize the use of more costly and hazardous types of energy.

Kuwait has one of the most severe arid climates in the world with limited fresh water available. The rainfall on average is only 130 mm per year. Most of the rainwater is lost to sea due to the geographic location on a narrow band along the Gulf Coast. The country's water supply is provided by costly desalinated water. Per capita, water use is almost 300 liters/person/day and has a notable upward trend. To maintain a sustainable development in the social, economical, technical and industrial renaissance in the country, the nation needs an integrated water resource management plan. Such a plan must incorporate every feasible and possible way of augmenting water sources and their appropriate uses.

### Solar Energy

The solar process is the process where sun radiation is used as a source of energy. Solar energy is increasing quickly as a renewable energy alternative to energy-intensive processes such as multi-stage flash desalination, where energy costs are high. Solar energy is abundant and significantly cheaper than other ways of producing energy. A recent paper by Franz and Hans (2008) presented a long-term scenario for the demand of freshwater in the Middle East and North Africa (MENA). They showed how freshwater demand may be covered by a better use of the existing renewable water sources and by sea water desalination powered with solar energy. The study also shows the potential of using Concentrated Solar Power (CSP) that offers a sustainable energy source. CSP could cover the future freshwater deficits and shortages resulting from population and industrial growth. Another work by Glueckstren (1995) assessed the cost effectiveness of large solar desalination systems and evaluated a comparative cost of full and partial desalting systems. It was concluded that salt gradient ponds to power hybrid multi-effect distillation/sweater reverse osmosis systems are currently the preferred technology for large-scale desalination. However, most of the current solar applications employ expensive sophisticated cells to generate energy.

The present disclosure utilizes resources such as solar radiation naturally as a sustainable energy, without costly solar collectors and cells, to cover or reduce the deficit caused by high freshwater demands especially during the summer season due to modernization, population growth and severe weather. Sustainability means abundant, affordable, compatible with society, and safe for the environment. Using such a clean, unlimited and economical source of power must be considered by MENA governments to cope with the rapid progress and development of solar thermal power plants worldwide. FIG. 1 shows the solar energy irradiated on the desert and coasts of MENA countries. The MENA region including the gulf peninsula is exposed to and experiences the highest solar irradiance, of up to ≥2800 kWh/m²/y. Each square kilometre of land in MENA receives each year an amount of solar energy equivalent to 1.5 million barrels of crude oil (Saghir et al., 2000). This cheap, clean, renewable, abundant energy could be invested positively to replenish freshwater resources.

During the summer season the air layer above the sea level is nearly saturated with water vapor. This vapor is used by some of the poor countries in MENA for distilled water irrigation purposes. This is achieved by obstructing the wind direction with a cool surface and collecting the condensate on trays as shown in FIG. 2. The main drawbacks for such wind driven units are the variable wind speed and direction, and limited production. A need exists for desalination cooling systems and methods solving the aforementioned problems.

### SUMMARY

A desalination and air cooling system is disclosed, the system including a desalination chamber, a ventilation structure and a cooling tower. The ventilation structure is attached to the desalination chamber and includes a fan and a heat exchanger. A pump and fluid conduits provide cooling liquid that is circulated within the heat exchanger. A cooling tower is provided including a base storage portion holding the cooling liquid, a middle portion, and a top outlet portion. One or more inlets are included for the introduction of air onto a top surface of the cooling liquid. The middle portion and top outlet portion are configured to induce a convection current which causes cooler air to be introduced from the one or more inlets and warmer air to exit from the top outlet portion. The middle portion of the cooling tower may be tapered and the top outlet portion may be a dark opaque color that is heated by sunlight to create warm air within the top outlet portion and induce cooler air to enter through the one or more inlets of the cooling tower.

The desalination chamber includes a base, one or more sidewalls, a ceiling, and one or more transparent windows for passing sunlight onto saltwater held within the desalination chamber. The desalination chamber may include one or more condensate collection troughs for gathering condensate of evaporated saltwater formed within the desalination chamber. The base of the desalination chamber may be a dark opaque color for increased absorption of sunlight. One or more magnifying lenses or solar concentrators may be included for focusing sunlight into the desalination chamber.

In an embodiment, the desalination chamber may include one or more sidewalls which taper laterally outward from a base to the ceiling. In addition, one or more pressure regulating vents may be included in the desalination chamber.

Further disclosed herein is a method of cooling air and desalinating water. The method includes desalinating water in a desalination chamber and suctioning air from the desalination chamber using a fan through a duct and passing the air over a heat exchanger containing cooling fluid. Cooling fluid is introduced into the heat exchanger from a cooling tower, and a convection current having a cooling effect is induced on a top surface of the cooling fluid within the cooling tower. The method may include storing cooling fluid in a base portion of the cooling tower, heating air in a top outlet portion of the cooling tower, and introducing cool air onto a top surface of the cooling fluid through one or more air inlets of the cooling tower.

These and other features of the present subject matter will become readily apparent upon further review of the following specification.

### BRIEF DESCRIPTION OF DRAWINGS

FIG. 1 is an image of the annual direct solar irradiance in Middle East and Northern Africa countries and southern Europe.

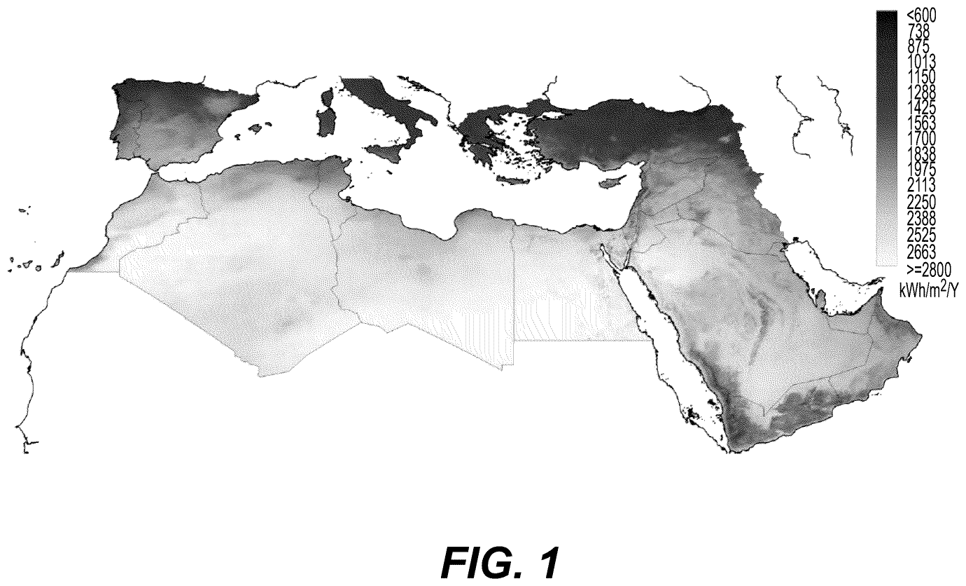

FIG. 2 is an illustration of distilled water production from water vapor driven by wind.

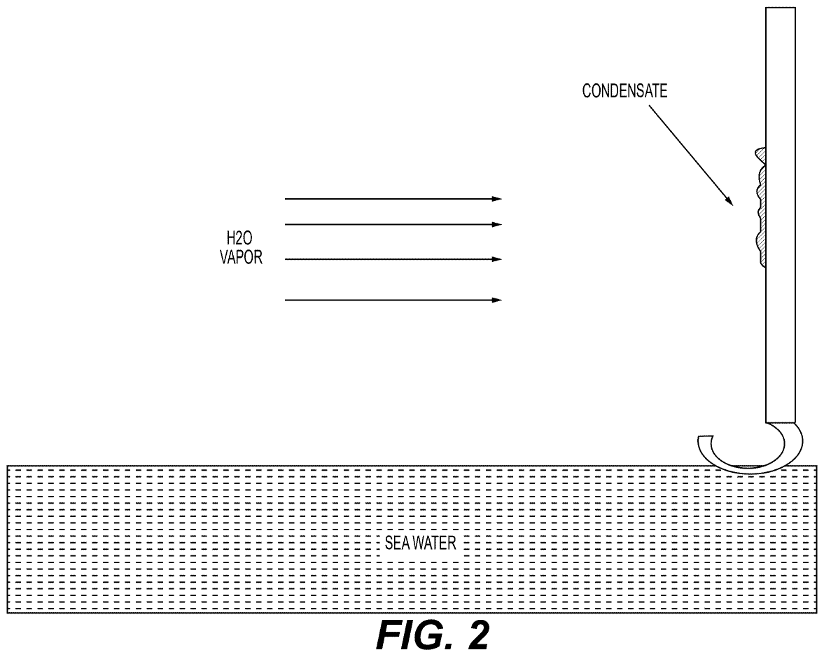

FIG. 3 is a schematic illustration of a desalination and air cooling system.

FIG. 4 is schematic illustration of a desalination unit having outwardly tapered side walls.

FIG. 5 is a schematic illustration of a multi-unit desalination and air cooling system.

Similar reference characters denote corresponding features consistently throughout the attached drawings.

### DETAILED DESCRIPTION

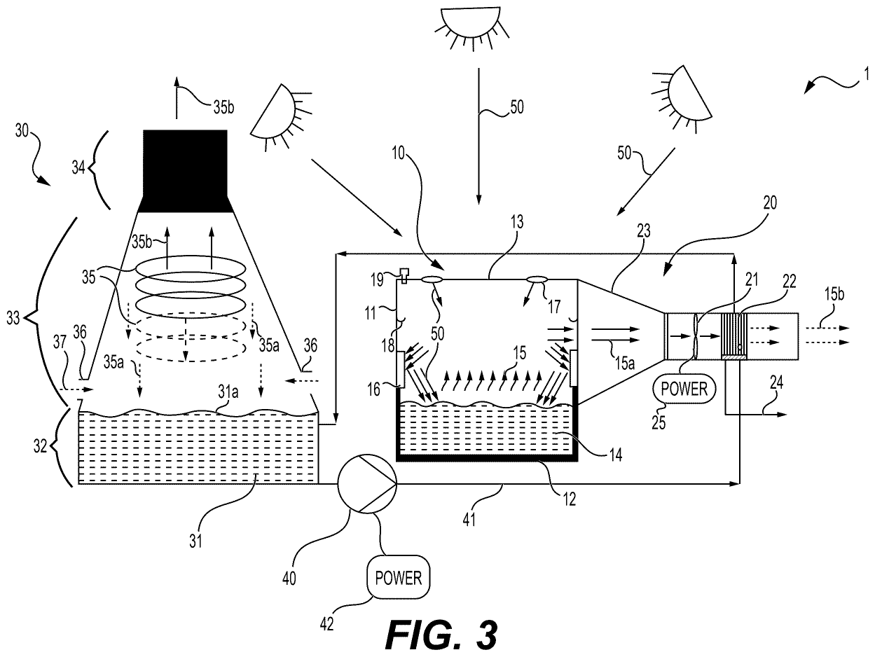

A desalination and air cooling system (also described as “the system”) 1 is disclosed in the non-limiting embodiment of FIG. 3. The system 1 includes a desalination chamber 10, a ventilation structure 20 and a cooling tower 30. The ventilation structure 20 is attached to the desalination chamber 10 and includes a fan 21 and a heat exchanger 22 positioned with a duct 23. A pump 40 and fluid conduits 41 provide cooling liquid 31, such as seawater, that is circulated within the heat exchanger 22. Pump 40 and fan 21 are connected to suitable respective power sources 42, 25 such as solar panels, grid power, batteries or any other suitable source of electric power.

A cooling tower 30 is provided including a base storage portion 32 holding the cooling liquid 31, a middle portion 33, and a top outlet portion 34. The middle portion 33 and top outlet portion 34 are configured to induce a convection current 35, which causes cooler air 35a to travel downward towards a top surface 31a of the cooling liquid 31 and warmer air 35b to travel upwards through the top outlet portion 34 exiting the tower.

As used herein, the phrase ‘induce (or inducing, induces, induction of) a convection current’ indicates the application of heat to air residing in an upper region of the cooling tower, whereby this application of heat causes the warmer, less dense air to rise upward, and the cooler, denser air to travel downward. In the non-limiting example of FIG. 3, the convection current 35 is induced by the application of heat in top outlet portion 34. Sunlight is absorbed on outlet portion 34 due to a dark opaque color thereon having low surface albedo, i.e. causing increased absorption of the sunlight. Dark opaque colors would include preferably black, but also dark navy blue, and dark purple, as non-limiting examples. The heating of outlet portion 33 by sunlight causes air within outlet portion 34 to be at an elevated temperature and have a lower density compared to the air in other parts of cooling tower 30. Middle portion 33 may be coated by a reflective or high surface albedo color, such as white or a mirror, causing a lower amount of sunlight to be absorbed, and resulting in a lower air temperature within middle portion 33.

As a result of the differences in air density caused by heating air within outlet portion 34, the higher density, cooler air 35a will descend towards the cooling liquid 31 while the lower density, warmer air 35b will rise upward and exit through outlet portion 34. Due to the tapered shape of middle portion 33, convection current 35 takes on a vortex shape and causes cool outside air 37 to be suctioned into one or more air inlets 36 and onto a top surface 31a of the cooling liquid 31.

While FIG. 3 depicts a specific example of inducing a convection current, the example is non-limiting and other methods of inducing a convection current may be applied within the spirt of the disclosure set forth herein. For example, other heating means may be provided for top outlet portion 34, such as an electric heater powered by a solar panel or other power source. Also, openings 36 may be provided in alternate amounts and/or locations to that which is shown.

With reference to the desalination chamber 10 of FIG. 3, in a non-limiting example, desalination chamber 10 is a solar desalination chamber including one or more sidewalls 11, a base 12, and ceiling 13. One or more transparent windows are provided in desalination chamber 10, provided on walls 11 and/or ceiling 13. Ceiling 13 in the example of FIG. 3 is completely transparent and forms the one or more windows for passage of sunlight 50 therethrough to contact saltwater 14 which is heated by sunlight 50 to produce water vapor 15. One or more solar concentrators 16 may be included for directing sunlight 50 onto saltwater 14. Solar concentrators 16 are shown positioned within desalination chamber 10 but may also be positioned outside the chamber and direct sunlight 50 through the transparent window(s) onto the saltwater 14. In addition, one or more magnifying lenses 17 may be included for focusing sunlight 50 onto saltwater 14. Base 12 may be formed of stainless steel or copper due to their heat transfer properties, and may be coated with a dark opaque color to further promote absorption of sunlight by saltwater 14.

As saltwater 14 is heated, it produces vapor 15, and one or more collection troughs 18 may be provided for gathering condensate which develops on the ceiling 13 or walls 11. Troughs 18 may be suitably connected to conduits and a storage vessel (not shown) for storage of desalted, purified water. One or more pressure regulating vents 19, such as conical ejectors, may be provided for selectively opening and closing, and thereby regulating pressure within desalination chamber 10. In addition, as vapor 15 is produced, fan 21 of ventilation section 20 will suction out warm air 15a and pass it over heat exchanger 22 where it will produce both purified water as condensation 24 gathered on heat exchanger 22, as well as cool air 15b passing over heat exchanger 22.

In addition to system 1 of FIG. 3, the present disclosure is directed to a method of cooling air and desalinating water. The method includes desalinating water 14 in a desalination chamber 10 and suctioning warm air 15a from the desalination chamber 10 using a fan 21 through a duct 23 and passing the warm air 15a over a heat exchanger 22 containing cooling fluid 31. Cooling fluid 31 is introduced into the heat exchanger 22 from a cooling tower 30, and a convection current 35 having a cooling effect is induced on a top surface 31a of the cooling fluid 31 within the cooling tower 30. The method includes storing cooling fluid 31 in a base portion 32 of the cooling tower, heating air in a top outlet portion 34 of the cooling tower, and introducing cool air 37 onto a top surface 31a of the cooling fluid 31 through one or more air inlets 36.

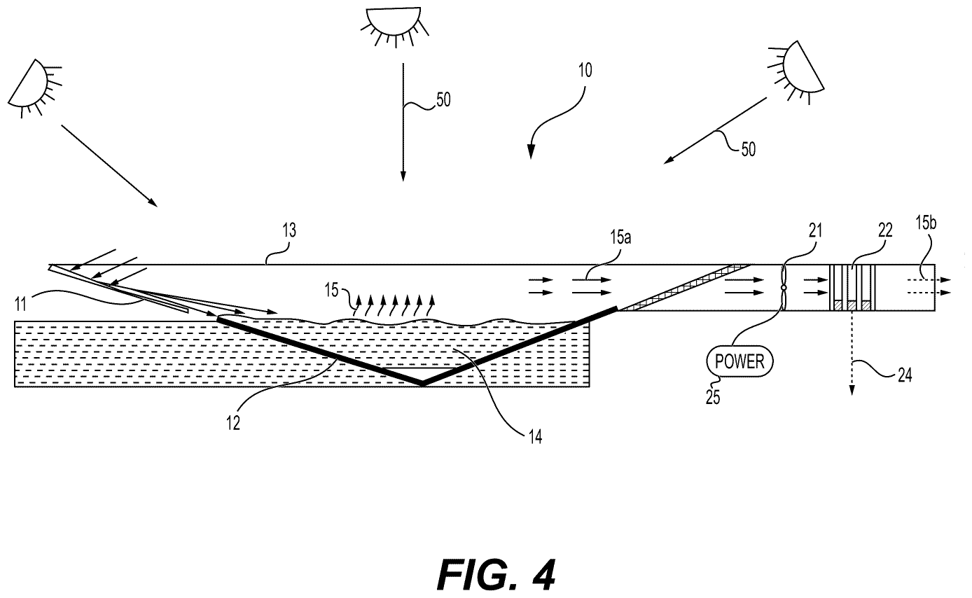

Turning to FIG. 4, an embodiment of desalination chamber 10 is shown in which walls 11 taper outward from base 12 to ceiling 13. In this embodiment, the ceiling 13 again serves as the transparent window for the desalination chamber but with a larger surface area on which vapor 15 may gather to produce desalinated condensate water.

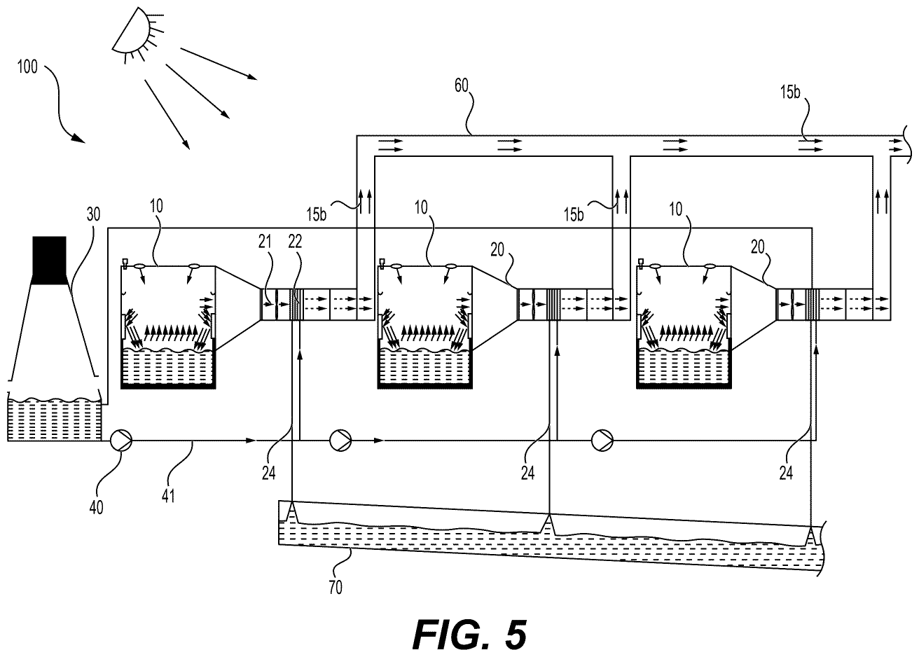

FIG. 5 shows an example of a multi-stage desalination and air cooling system 100. System 100 includes a single cooling tower 30 and multiple desalination units 10. A collective conduit 70 is provided for gathering the combined production of desalinated water 24 from desalination units 10. A collective duct 60 is provided for the combined collection of cooling air 15b. The example is non-limiting, however, and different combinations of cooling towers 30 and desalination units may be provided in similar configurations for providing larger amounts of desalinated water and cooled air.

It is to be understood that the desalination and air cooling systems are not limited to the specific embodiments described above, but encompass any and all embodiments within the scope of the generic language of the following claims enabled by the embodiments described herein, or otherwise shown in the drawings or described above in terms sufficient to enable one of ordinary skill in the art to make and use the claimed subject matter.

1. A desalination and air cooling system, comprising:
a desalination chamber;
a ventilation structure, wherein the ventilation structure is attached downstream of the desalination chamber and includes a fan and a heat exchanger;
a pump and fluid conduits providing cooling liquid circulated within the heat exchanger; and
a cooling tower including a base storage portion holding the cooling liquid, a middle portion, a top outlet portion, and one or more inlets for the introduction of air onto a top surface of the cooling liquid, wherein the middle portion and top outlet portion are configured to induce a convection current in a vortex shape which causes cooler air to be introduced from the one or more inlets and warmer air to exit from the top outlet portion,
wherein the middle portion of the cooling tower is tapered from a wider section proximate the base storage portion to a narrower portion proximate the top outlet portion, and
wherein the middle portion of the cooling tower is coated by a reflective surface.

2. (canceled)

3. The desalination and air cooling system as recited in claim 1, wherein the top outlet portion is a dark opaque color and is heated by sunlight to create warm air within the top outlet portion and induce cooler air to enter through the one or more inlets of the cooling tower.

4. The desalination and air cooling system as recited in claim 1, wherein the desalination chamber includes a base, one or more sidewalls, a ceiling, and one or more transparent windows for passing sunlight onto saltwater held within the desalination chamber.

5. The desalination and air cooling system as recited in claim 4 wherein the desalination chamber includes one or more condensate collection troughs for gathering condensate of evaporated saltwater formed within the desalination chamber.

6. The desalination and air cooling system as recited in claim 4 wherein the base of the desalination chamber is a dark opaque color.

7. The desalination and air cooling system as recited in claim 4, wherein the desalination chamber includes one or more magnifying lenses formed therein.

8. The desalination and air cooling system as recited in claim 4 further comprising one or more solar concentrators which direct sunlight onto saltwater within the desalination chamber.

9. The desalination and air cooling system as recited in claim 1, wherein the desalination chamber includes one or more pressure regulating vents formed therein.

10. The desalination and air cooling system as recited in claim 4, wherein the one or more sidewalls of the desalination chamber taper laterally outward from the base to the ceiling.

11. The desalination and air cooling system as recited in claim 1 further comprising an additional two or more desalination chambers each in connection with a respective ventilation structure, respective heat exchanger and respective fan.

12. A method of cooling air and desalinating water comprising:
storing a cooling fluid in a base portion of a cooling tower;
heating air in a top outlet portion of the cooling tower;
introducing cool air onto a top surface of the cooling fluid through one or more air inlets of the cooling tower;
desalinating water in a desalination chamber;
suctioning air from the desalination chamber using a fan through a duct and passing the air over a heat exchanger containing cooling fluid from the cooling tower;
inducing a convection current in a vortex shape having a cooling effect on the top surface of the cooling fluid within the cooling tower; and
gathering condensate in the desalination chamber on a transparent ceiling of the desalination chamber and one or more side walls which taper laterally outward from a base of the desalination chamber to the transparent ceiling of the desalination chamber, wherein a middle portion of the cooling tower is coated by a reflective surface.

13. (canceled)

14. The method of cooling air and desalinating water as recited in claim 12 wherein the top outlet portion of the cooling tower is a dark opaque color used to attract sunlight and heat air within the top outlet portion.

15. The method of cooling air and desalinating water as recited in claim 12 further comprising directing sunlight through one or more transparent windows formed in the desalination chamber onto saltwater to cause evaporation of the saltwater.

16. (canceled)

17. The method of cooling air and desalinating water as recited in claim 15 further comprising focusing sunlight onto seawater in the desalination chamber using a magnifying lens.

18. The method of cooling air and desalinating water as recited in claim 15 further comprising covering one or more interior surfaces of the desalination chamber using a dark opaque color.

19. The method of cooling air and desalinating water as recited in claim 15 further comprising directing sunlight onto seawater in the desalination chamber using one or more solar concentrators.

20. The method of cooling air and desalinating water as recited in claim 12, further comprising suctioning air from additional multiple desalination chambers each using respective fans through a respective duct and passing the air over respective heat exchangers containing cooling fluid.
